(19) United States
(12) Patent Application Publication
(10) Pub. No.: US 2026/0299335 A1
(43) Pub. Date: Oct. 1, 2026

(54) TRAVELING-WAVE ACOUSTO-OPTIC MODULATOR ON THIN SILICON NITRIDE

(71) Applicants: Anello Photonics, Inc., Santa Clara, CA (US); Purdue Research Foundation, West Lafayette, IN (US)

(72) Inventors: Warren Bruce Jin, Santa Clara, CA (US); Scott Edward Kenning, West Lafayette, IN (US); Avi Feshali, Los Angeles, CA (US); Tzu-Han Chang, West Lafayette, IN (US); Sunil Ashok Bhave, West Lafayette, IN (US)

(21) Appl. No.: 19/558,299

(22) Filed: Mar. 5, 2026

Related U.S. Application Data
(60) Provisional application No. 63/779,904, filed on Mar. 28, 2025.
(60) Provisional application No. 63/996,549, filed on Mar. 4, 2026.

(51) Int. Cl. G02F 1/125; G02F 1/035

(52) U.S. Cl. CPC G02F 1/125; G02F 1/035

(57) ABSTRACT

An acousto-optic modulator (AOM) is developed on thin silicon nitride (SiN) photonics platform. Specifically, this disclosure demonstrates a novel technique to produce optically-broadband traveling-wave AOMs on thin SiN photonics platform, where the piezo-modulator layer can be above or below the SiN waveguides depending on design and process sequence during photonics chip fabrication. As SiN waveguides are compactly placed adjacent to one another with a proximity mostly dictated by the design rules, minimal additional chip area is required to produce larger and more efficient photonic spirals, while still maintaining the footprint of the photonic chip as compact.

### RELATED APPLICATIONS

This application is related to and claims the benefit of U.S. Provisional Patent Application No. 63/779,904, filed Mar. 28, 2025, titled “Traveling-Wave Acousto-Optic Modulator On Thin Silicon Nitride,” the entirety of which is incorporated herein by reference. This application is also related to and claims the benefit of U.S. Provisional Patent Application No. 63/996,549, filed Mar. 4, 2026, titled “Piezo-Modulator Integrated With Low-Loss Silicon Nitride Waveguides,” the entirety of which is incorporated herein by reference.

### TECHNICAL FIELD

The present disclosure relates generally to photonic devices, and particularly to optically-broadband modulators on foundry-fabricated thin silicon nitride photonics chip.

### BACKGROUND

Currently there is no optically-broadband modulator that exists on thin silicon nitride (SiN) photonics platform. On alternative material platforms, such as silicon, photonic spirals have been used. For example, see the reference paper by Y. Zhou, et al. Phys. Rev. X 14, 021002(2024). However, photonic spirals that are used on material platforms other than SiN are completely impractical for use in photonic integrated circuits, as light must leave the plane of the chip vertically. On thin SiN platform, optical ring resonators are used to resonantly enhance the acousto-optic interaction. For example, see the reference paper by J. Wang, et al. Opt. Express 30, 31816-31827 (2022). However, this solution is not optically-broadband, because optical ring resonator is inherently narrow-band.

Another paper titled “Piezo-optomechanically Tunable Untra-Low-Loss Silicon Nitride Waveguide Photonic Circuits” by Mishra et al. (CLEO 2025) discloses experimental characterization of low-confinement waveguide-based tunable directional couplers and reconfigurable MZIs with adjustable extinction ratios. However, the piezo layer for tunability is below SiN waveguides.

### SUMMARY

Disclosed here is a compact phase-matched photonic spiral (i.e., a compact spiral of photonic waveguide) fabricated on SiN platform. Surface acoustic waves (SAW) modulate the photonic spiral. This technology is optically-broadband, i.e., it works across a wide variety of wavelengths simultaneously. It has been experimentally verified to operate over the 1510 nm to 1630 nm wavelength regime. The acousto-optic modulator is based on a piezoelectric film patterned with interdigital transducers (IDT) that generates the surface acoustic wave. The piezoelectric film can be above the SiN waveguide or below the SiN waveguide. A surface acoustic wave (SAW) is an acoustic wave that travels along the surface of an elastic material, with its amplitude decaying exponentially with depth, confined to roughly one wavelength. The surface acoustic wave perturbs the compact photonic spiral, whose geometry is precisely determined to ensure the acousto-optic interaction is coherent and enhanced. The calculation associated with the geometry of the photonic spiral is a key differentiator of the performance of the modulator. The geometry of the spiral is novel and greatly simplifies a problem encountered on material platforms other than SiN (such as thin film lithium niobate and silicon photonics), because in other material platforms, light has to leave the plane of the photonic spiral. In the disclosed design on SiN platform, light stays in the plane of the photonic spiral.

The acousto-optic modulator in SiN photonics has been already fabricated using a commercial silicon nitride photonics process.

Though currently the acousto-optic modulators are designed for photonics wavelengths, the devices can be designed for the visible wavelength range too, which is of interest for cold-atom physics, classical sensing, and quantum sensing.

### BRIEF DESCRIPTION OF THE DRAWINGS

The present disclosure will be understood more fully from the detailed description given below and from the accompanying drawings of various implementations of the disclosure. Please note that the dimensions shown in the figures are for illustrative purposes only and not drawn to scale.

FIG. 1A illustrates a schematic diagram of a photonic chip with interdigital transducers (IDT) on top of a SiN waveguide core of a photonic spiral buried in silica cladding, according to an embodiment of the present disclosure.

FIG. 1B illustrates a schematic cross-sectional view of the photonic chip shown in FIG. 1A, according to an embodiment of the present disclosure.

FIG. 2 illustrates the design geometry of photonic spiral (seen from the top view) in the SiN layer and relative placement of IDT on the top layer, according to an embodiment of the present disclosure.

FIG. 3 illustrates an exploded view of adjacent individual turns (each turn is called a pass) of the photonic spiral on one side of the photonic spiral, according to an embodiment of the present disclosure.

FIG. 4A shows, according to embodiments of the present disclosure, a cartoon used to illustrate the phase-matching strategy.

FIG. 4B shows, according to embodiments of the present disclosure, a schematic representation of a photonic chip without Aluminum Nitride (AlN) deposited (left), and another photonic chip after the AlN deposition and IDT fabrication (right).

FIG. 4C shows, according to embodiments of the present disclosure, a schematic of a fully fabricated photonic chip undergoing testing;

FIG. 4D illustrates a schematic cross-sectional view of a photonic chip with an alternative layer stack with a thin molybdenum (Mo) underneath the AlN layer, according to an embodiment of the present disclosure.

FIG. 4E illustrates a scanning electron micrograph (SEM) showing the cross-sectional view of a cleaved photonic chip fabricated using the layer structure shown in FIG. 4D, according to an embodiment of the present disclosure.

FIG. 5A illustrates, according to embodiments of the present disclosure, (a) a heterodyne measurement setup to measure phase modulation.

FIG. 5B illustrates modulation index scaling with active segment count (pass count, N), according to an embodiment of the present disclosure.

FIG. 5C illustrates radio frequency (RF) drive frequency sweep, according to an embodiment of the present disclosure.

FIG. 5D illustrates drive power sweep, according to an embodiment of the present disclosure.

### DETAILED DESCRIPTION

An acousto-optic modulator (AOM) is developed on thin silicon nitride (SiN) photonics platform. Specifically, this disclosure demonstrates a novel technique to produce optically-broadband traveling-wave AOMs on thin SiN photonics fabrication process available in standard semiconductor foundries. As SiN waveguides are compactly placed adjacent to one another with a proximity mostly dictated by the design rules, minimal additional chip area is required to produce larger and more efficient photonic spirals. The technique presented helps close the gap between optically-broadband AOMs on ultra-low loss thin SiN platforms.

Integrated AOMs based on piezoelectric materials have found use in isolators and on-chip generation of sidebands for assorted control functionalities. Applying a voltage across the piezoelectric actuator material indices strain in the waveguide, resulting in a refractive index change due to strain-induced optical phase change, which can be detected by a photodetector. Achieving appreciable AO modulation without the use of optical resonant enhancement relies on high-confinement waveguides with favorable photoelastic properties such as silicon or thin film lithium niobate. Thin silicon nitride (SiN) photonics, however, lacks strong optical confinement and has therefore suffered from a lack of available modulators without relying on optical resonant enhancement of the effect. By noting the low optical loss of the thin SiN platform, this disclosure demonstrates modulators that exploit a long acousto-optic interaction length. The long acousto-optical interaction length is achieved by a photonic spiral, as described below. The careful optimization of the waveguide and modulator (actuator) geometry leads to reduction of propagation loss in the low-confinement thin SiN waveguide that is comparable to conventional high-confinement waveguides.

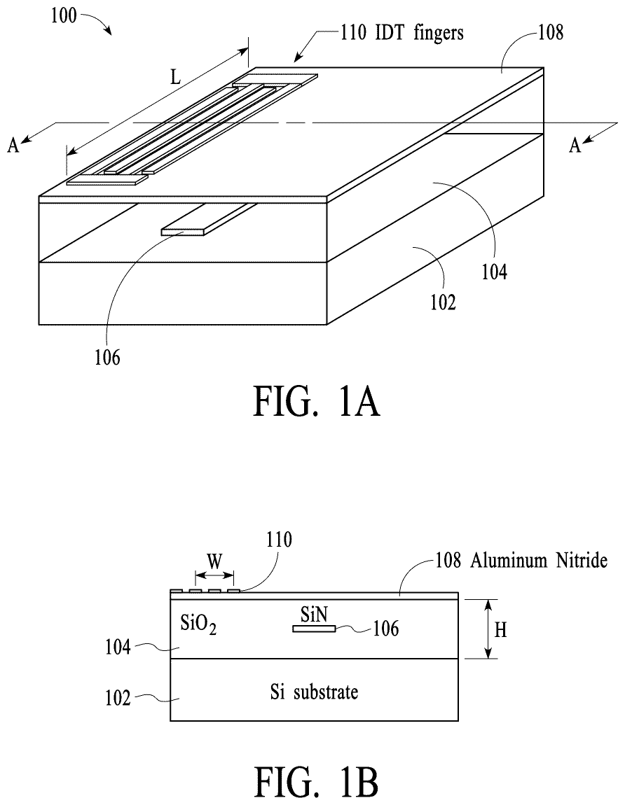

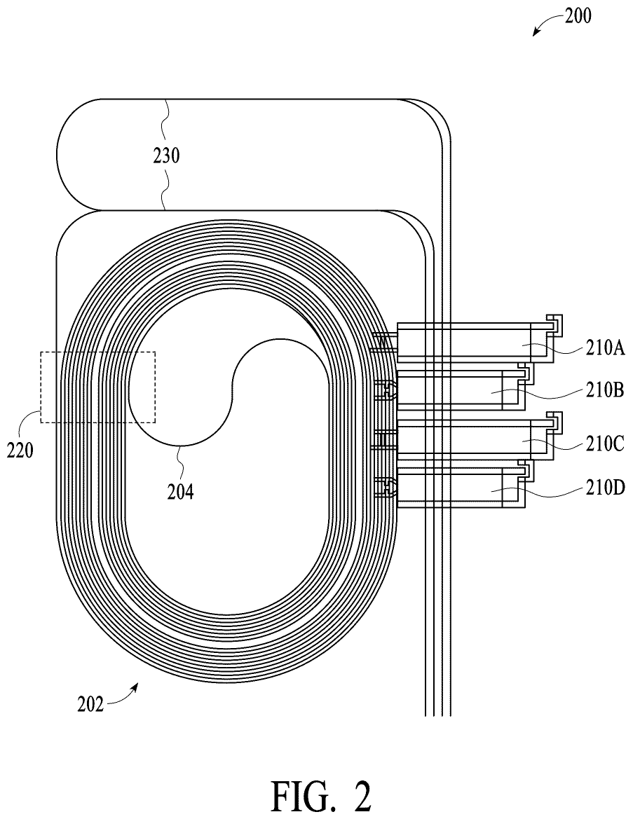

FIG. 1A illustrates a schematic diagram of a photonic chip 100 with interdigital transducers (IDT) on top of a SiN waveguide core 106 of a photonic spiral buried in silica (SiO₂) layer 104. Note that though in the figures the IDT is shown on top of a SiN core, in alternative embodiments the IDT can be integrated below the SiN waveguide too by altering the process sequence during fabrication. The SiN core 106 is surrounded by silica cladding (upper cladding and lower cladding) formed in the silica layer 104 on top of a silicon substrate 102. In the isometric view of FIG. 1A, the photonic chip 100 has the IDT fingers are on top of an aluminum nitride (AlN) layer 108. The IDT fingers can be made of aluminum or other metals compatible with AlN layer 108. The AlN layer 108 can be directly deposited on top of the silica layer 104. The length of the IDT fingers is shown as “L”, and double the pitch between adjacent fingers is “W” as shown in FIG. 1B. In some embodiments, W can be 8 μm, though this dimension and any other dimension in this disclosure are non-limiting the scope of the disclosure. Note that the number of IDT finger pairs is much higher than the two finger pairs shown in FIG. 1A for illustrative purposes.

FIG. 1B shows the cross-sectional layer structure (along cut line AA′ shown in FIG. 1A). The thickness of the silica cladding layer 104 is shown as “H”. In some embodiments, H can be 10 μm, though this dimension and any other dimension in this disclosure are non-limiting the scope of the disclosure.

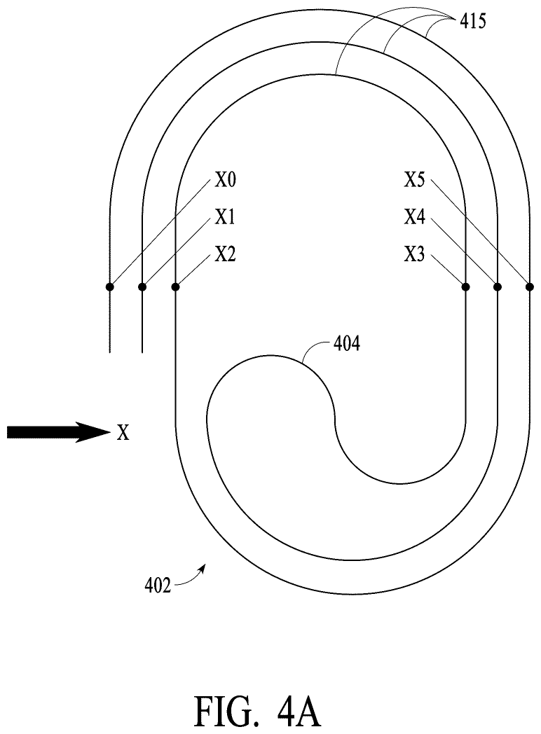

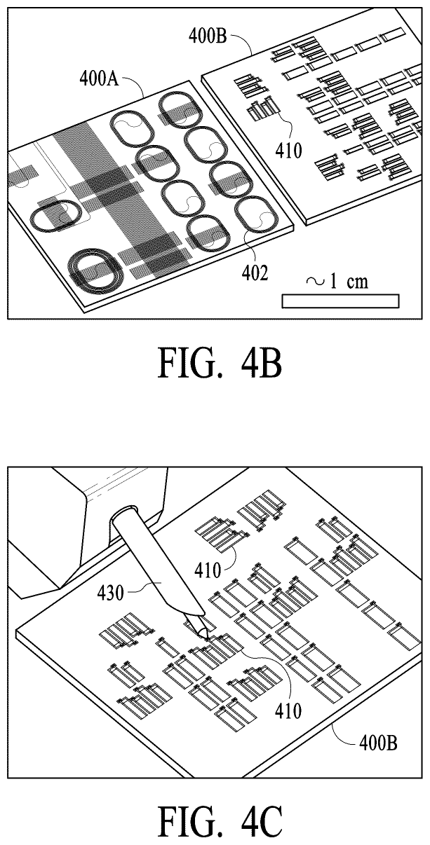

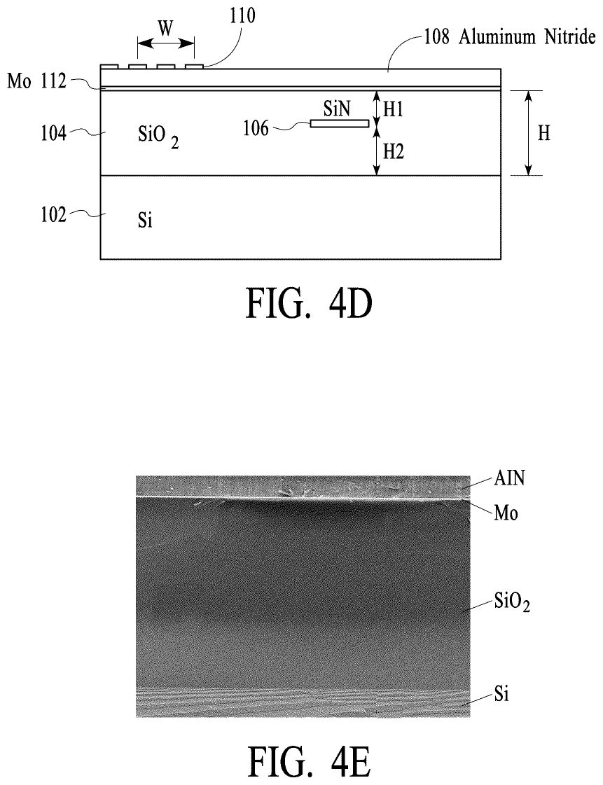

In alternative embodiments, as shown in FIGS. 4D, and 4E, there can be a thin molybdenum (Mo) layer in between the silica cladding 104 and the AlN top layer 108.

FIG. 2 illustrates the design geometry of a phase-matched photonic spiral 202 (seen in a top view 200) in the SiN layer and relative placement of IDT fingers 210A, 210B, 210C and 210D on the top layer. The photonic spiral has many turns (passes) per side with the S-shaped bend 204 in the middle connecting two sides of the photonic spiral 202. A simplified version of a portion 402 of the photonic spiral 202 is shown in FIG. 4A showing only a few adjacent turns in the inside and the S-shaped bend 404 (similar to 204). The S-shaped bend is called a switchback waveguide. In an example, number “N” of passes may be in the range of twenty (e.g., N=19), or in the range of hundreds, based on the length requirement. There are other waveguide-based structures (e.g., 230) fabricated on the wafer that may include splitters, couplers etc. that are adjacent to the photonic spiral 202.

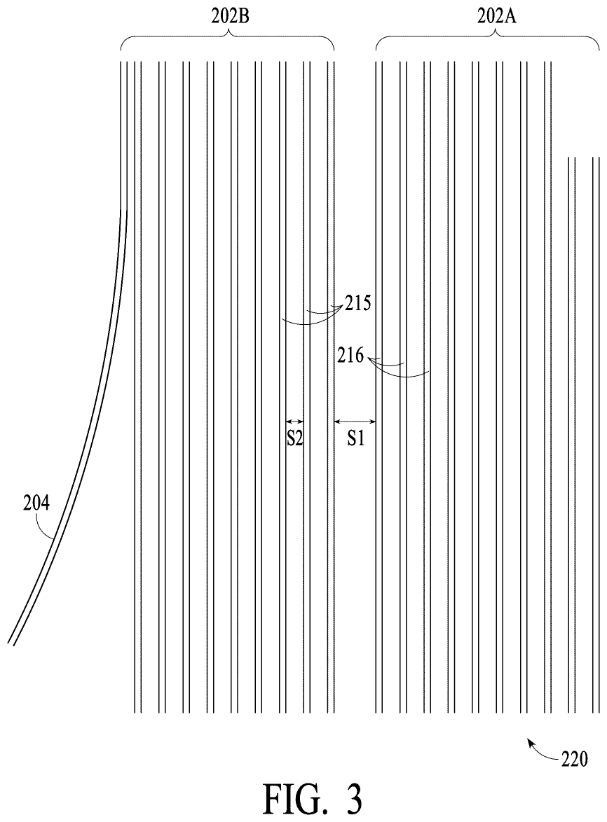

FIG. 3 illustrates an exploded (zoomed in) top view of a portion of the photonic spiral 202 that is within the dotted lined box 220 in FIG. 2. FIG. 3 shows adjacent individual turns (each turn is called a pass) of the photonic spiral 202 on one side of the photonic spiral, according to an embodiment of the present disclosure. The curved waveguide on the left is part of the switchback waveguide (S-shaped bend 204) connecting one side of the spiral with the other side. Notice how the spacing is usually same (labeled as S2, where S2 can be close to 16 μm in a non-limiting example) between the turns 215, 216 with the exception of the width labeled S1 (an example value of S1 can be 23.8 μm) between two positions 202A and 202B of the same coil 202. Sometimes spacing corrections can be anomalously high, but the overall phase match is still correct. Additionally, the switchback waveguide gets close to the interior-most straight section. This can also be easily corrected by increasing the minimum spacing. Appendix A shows degradation of phase shift in accordance with waveguide placement error and error in effective index.

Appendix A also provides the details of phase matching methodology in a photonic spiral. Appendix A is incorporated by reference herein in its entirety.

In the context of acousto-optic modulators (AOMs), VπL represents the voltage-length product, a figure of merit that indicates the modulation efficiency of the device. It is calculated by multiplying the half-wave voltage (Vπ) required to induce a π phase shift by the interaction length (L) of the device. Simply modulating a single waveguide segment with a surface acoustic wave (SAW) will require enormous drive voltages to achieve meaningful modulation on the layer stack shown in FIG. 1A or FIG. 4D. Existing methods to reduce the voltage do not address the challenges of thin SiN. For example, compact serpentine waveguides cannot be used on thin SiN as the waveguide bending radius is several hundred microns on SiN platform. Additionally, waveguide spirals used in existing photonic devices only “spiral in” and require grating couplers to access the modulated light in the center. This restricts use in photonic integrated circuits, as the light leaves the plane of the photonics chip. The current disclosure overcomes both of these challenges for intra-band modulation with an innovative approach to phase-match compact waveguide spiral with a switchback waveguide as shown in FIG. 2.

The optically-broadband acousto-optic modulator of this disclosure, implemented by a compact phase-matched photonic spiral, foundry-fabricated on thin SiN photonics platform, achieves a VπL of 3.64 V·cm at 1550 nm wavelength.

FIG. 4A illustrates a cartoon used to illustrate the phase-matching strategy (as detailed in Appendix A) in a photonic spiral 402 (similar to spial 202) with turns 415 (similar to the turns 215). In FIG. 4A, the active segment positions are labeled as Xᵢ, with i increasing with distance from the transducer. Light does not travel sequentially with this labeling scheme, instead propagating in the order 0, 5, 2, 3, 4, 1 (i.e., from X0 to X5 to X2 to X3 to X4 to X1). The position of the active segments, {Xᵢ}, is calculated for a spiral of an arbitrary number of active segments (i.e., passes or turns), N, factoring in waveguide lengths for group-delay compensation. The placement of active segments is aperiodic in general, but converges to integer multiples of SAW wavelength in the small spiral limit.

FIG. 4B shows photonic chips with spirals at various stages of fabrication. Specifically, FIG. 4B shows on the left a photonic chip 400A showing multiple photonic spirals 402 (i.e. SiN cores surrounded by silica cladding) fabricated on it. FIG. 4B shows on the right another photonic chip 400B where the photonic spirals are no longer visible, as a layer of aluminum nitride (AlN) has been deposited on top of the silica upper cladding, and IDT 410 has been fabricated on top of the AlN layer, as shown in FIG. 1 and FIG. 4D. FIG. 4C shows a fully fabricated photonic chip 400B, with the photonic spirals and IDT 410 formed on top (therefore photonic spirals are not visible from top), undergoing testing with an RF probe 430.

As described above, FIG. 4D shows an alternative layer stack with a thin layer 112 of molybdenum (Mo) underneath the AlN layer 108 to facilitate AlN layer fabrication. In an example, the upper and lower cladding in the silica layer 104 can have same of different thicknesses. For example, upper cladding thickness H1 can be 4 μm and lower cladding thickness H2 can be 6 μm. FIG. 4E shows a cross section scanning electron micrograph (SEM) of a cleaved photonic chip with layer structure schematically shown in FIG. 4D.

The innovative solution disclosed here has been used to design photonic spirals with active segment lengths (for example, L=1.6 mm) to accommodate a few prototype transducers per spiral. In an example embodiment, the largest spiral occupies a minimally sized rectangle of 3595 μm×5540 μm and has a total waveguide length of 261 mm. The 60 nm thick Aluminum interdigital transducers (IDTs) have a selected pitch of 4 μm aperture width of 376 μm and 196 IDT finger pairs.

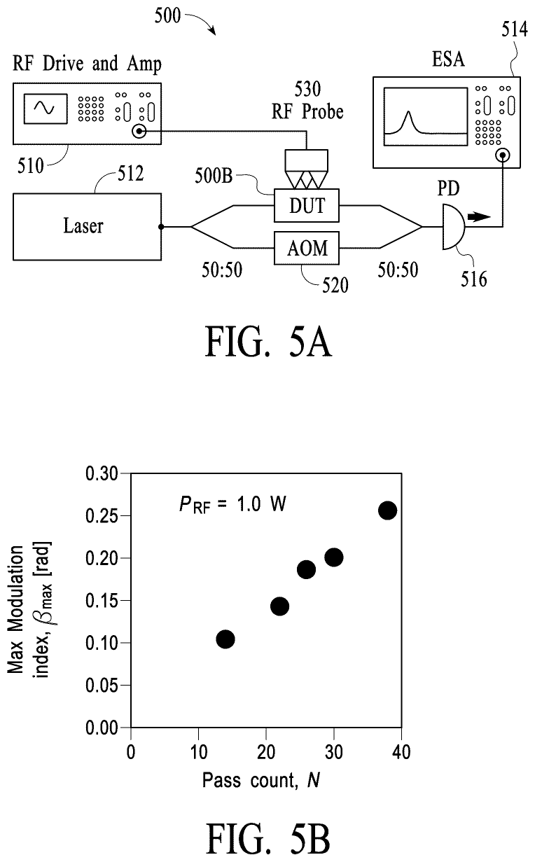

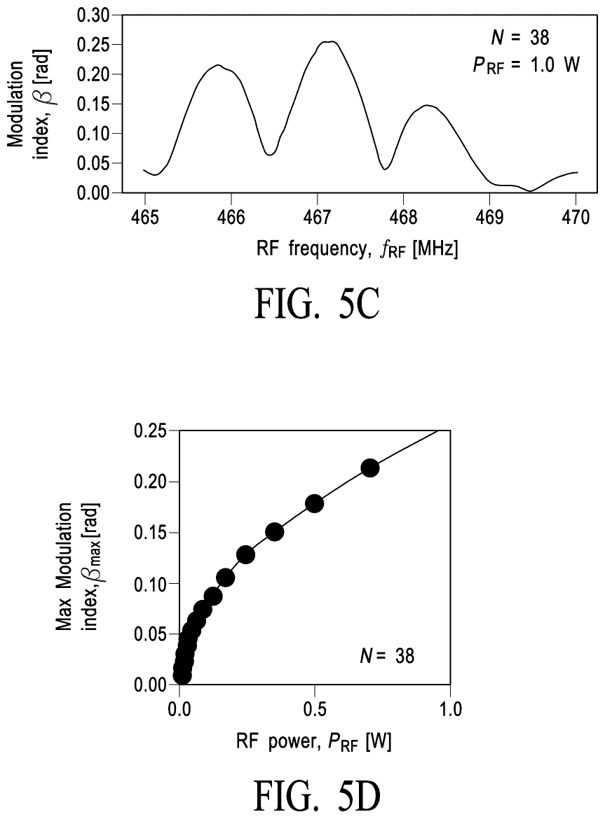

Devices are measured using a heterodyne interferometry setup 500, illustrated in FIG. 5A. The setup includes an RF Drive and amplifier 510, RF probe 530 that probes the device under test (DUT) 500B, a laser 512, an AOM 520, a photodetector (PD) 516 and a spectrum analyzer 514. Laser light is split 50:50 into the DUT 500B and the AOM 520 and then the optical signals are coupled back at a 50:50 coupler to be detected by the photodetector 516 to examine the phase match. FIGS. 5B and 5C validate that the spirals are properly phase matched. FIG. 5B shows linear scaling of the modulation index with increased active segment count for RF power 1.0 Watts, while FIG. 5C shows a fringing pattern due to coherent modulation of the near and far side of the spiral with a single transducer. FIG. 5D shows how the modulation index scales with incident RF power. From results shown in FIGS. 5B-D, a VπL of 3.64V·cm is calculated based on transducer aperture and the N=38 spiral (i.e. the spiral has 38 passes). The VπL is roughly double that of silicon waveguides, demonstrating the superiority of using SiN spiral instead of silicon spiral.

Please note that though in the figures, the piezoelectric layer AlN is shown to be on top of the upper cladding of the SiN waveguide core, with an alternate process for fabrication, the AlN layer can be underneath the lower cladding of the SiN waveguide core, i.e. an “upside-down” version of photonics chip fabricated using the technology described in the paper titled “Piezo-optomechanically Tunable Untra-Low-Loss Silicon Nitride Waveguide Photonic Circuits” by Mishra et al. (CLEO 2025) can be within the scope of this disclosure's photonics spiral and actuator design.

Though this disclosure uses AlN as the piezoelectric material, other materials, such as lead zirconate titanate (PZT) can be used as the piezoelectric material.

1. An acousto-optic modulator comprising:
a photonic spiral comprising a low-loss silicon nitride (SiN) waveguide core;
a piezoelectric material layer fabricated adjacent to the photonic spiral; and
an actuator that actuates the piezoelectric material to generate surface acoustic waves (SAW) that modulate optical phase in the photonic spiral.

2. The acousto-optic modulator of claim 1, wherein the SiN waveguide core of the photonic spiral is sandwiched between an upper cladding and a lower cladding.

3. The acousto-optic modulator of claim 2, wherein the upper cladding and lower cladding comprise silica.

4. The acousto-optic modulator of claim 2, wherein the piezoelectric material layer is fabricated on top of the upper cladding, or beneath the lower cladding.

5. The acousto-optic modulator of claim 4, wherein the piezoelectric material layer comprises aluminum nitride or lead zirconate titanate (PZT).

6. The acousto-optic modulator of claim 1, wherein the actuator comprises an interdigital transducer (IDT).

7. The acousto-optic modulator of claim 6, wherein a length of a finger pair of the IDT and a pitch between two fingers in a finger pair of the IDT are designed to create phase-matching in the photonic spiral.

8. The acousto-optic modulator of claim 7, wherein a number of turns in the photonic spiral depends on a total length of waveguide needed to achieve phase-matching in the photonic spiral.

9. The acousto-optic modulator of claim 1, wherein an S-shaped switchback waveguide connects an innermost turn of a first side of the photonic spiral to an innermost turn of a second side of the photonic spiral.

10. The acousto-optic modulator of claim 9, wherein a spacing between adjacent turns of the photonic spiral is adjusted to ensure phase-matching.

11. The acousto-optic modulator of claim 10, wherein a phase error created by a spacing between the switchback waveguide and the innermost turn of any side of the photonic spiral is compensated by adjusting spacing between two adjacent waveguides.

12. The acousto-optic modulator of claim 6, wherein fingers of the IDT comprises aluminum.

13. The acousto-optic modulator of claim 5, wherein an intermediate layer separates the piezoelectric material layer and the upper cladding or lower cladding.

14. The acousto-optic modulator of claim 13, wherein the intermediate layer comprises molybdenum.
